(19) United States
(12) Patent Application Publication
(10) Pub. No.: US 2024/0072255 A1
(43) Pub. Date: Feb. 29, 2024

(54) METHOD OF PREPARING VSE2 MATERIAL AND ELECTROCHEMICAL WHOLE CELL AND ELECTROCHEMICAL SYMMETRIC CELL USING THE SAME

(71) Applicant: THE HONG KONG UNIVERSITY OF SCIENCE AND TECHNOLOGY, HONG KONG (CN)

(72) Inventors: ZHENGTANG LUO, HONG KONG (CN); Yuyin LI, HONG KONG (CN); HOI LUN WONG, HONG KONG (CN)

(21) Appl. No.: 17/899,664

(22) Filed: Aug. 31, 2022

(51) Int. Cl. H01M 4/58; H01M 4/42

(52) U.S. Cl. CPC H01M 4/581; H01M 4/42; H01M 2004/027

(57) ABSTRACT

An anode materials VSe2/Zn, including a functional Vanadium diselenide (VSe2) with graphene support composite coated on the Zn metal with super ion conductivity, is used in a zinc ions battery. The synthesis process includes polymerization and chemical vapor deposition process for selenization with selenium powder.

### TECHNICAL FIELD

The present technology is generally related to electroactive materials and cells using such electroactive materials exhibiting ultra-stable cyclic life, and high columbic efficiency, and a methods of preparing the electroactive materials, in particular to a method of preparing a VSe₂ material and an electrochemical whole cell and an electrochemical symmetric cell using the same.

### BACKGROUND

With the increasing use of renewable energy, rechargeable metal ions batteries have stimulated great attention in the research. Among these, Zn ions batteries (ZIBs) are considered as one of the most promising candidates for high energy storage due to the numerous advantages, including the outstanding theoretical specific capacity (5855 mAh cm⁻³), proper potential of −0.76 V compared with standard hydrogen electrode, excellent ionic conductivity (two orders higher than that of organic electrolytes), more abundant raw materials than lithium ions batteries and superior safety working environment. As for the working principles of ZIBs, Zinc ions react at both electrodes and travel between them through a water-based electrolyte.

However, the dendrite formation during the cycling and the occurrence of parasitic hydrogen evolution reaction (HER) occurrence in the water-based system hinder its application and commercialization. Specifically, the uneven distribution of zincates migrates towards the tips of the protuberances on the anode surface during deposition process resulting in the severe dendrite growth. The dendrite formed during the continuous cycling causes low Columbic Efficiency (CE) and poor cycle lifespan. Moreover, the generated dendrites will penetrate through the separator, leading to short-circuit failure and fire explosion of the battery. Besides, since the zinc has a more negative redox potential than hydrogen, the HER on the anode surface consumes the water in the electrolyte, corrodes the electrode surface. In addition, the subsequent gas generation from the HER process would make battery unstable and may cause electrolyte leakage.

To date, extensive strategies have been proposed to tackle these problems, including zinc metal anodes structural design, modification of the anode-electrolyte interface, and optimization of the electrolyte composition. It has been revealed that Zn anodes with more exposed (002) basal facets exhibit less active electrochemically and HER inhibition, in comparison with the (100) or (101) plane based on the theoretical analysis. Controlling the (002) texture formation by the strategies mentioned above, which should be horizontally well-aligned along the deposition surface, will be an ultimate method to realize dendrite-free Zn deposition. Some researchers tended to work on the sheared-graphene functional substrate, which shows a relatively small lattice mismatch with Zn (002), facilitates the Zn deposition in a hexagon morphology with (002) orientation parallel to the substrate surface. Besides, an in-situ growth ZnSe cultivator was exploited to regulate (002) formation at the infancy stage, which is beneficial to inhibit the dendrite origination. However, to our best knowledge, no efficient approach to increase Zn (002) texture and inhibit the HER side reaction simultaneously has been proposed so far. The formation of homogeneous, compact and well-oriented zinc surface is the key point to obtain high capacity and long cycle life in the ZIBs.

### SUMMARY

In one aspect, a method of preparing a VSe₂ material with graphene support composite active materials is provided, where the method includes the selenization via chemical vapor deposition (CVD) process. And confinement of V⁵⁺ ions by the electrostatic interactions between the amine groups from polydopamine (PDA) and VO₃⁻. The details are shown below:
S1: preparing graphene oxide (GO) was prepared by a modified Hummers method, which chemically separate the graphite interlayer by adding functional groups and then dispersing the GO into 100 ml of the deionized (DI) water to obtain GO solution;
S2: adding 200 mg of polydopamine into the GO solution and stirring for 30 minutes to ensure a good mix; adding 100 mg of Tris-HCl into dispersion and vigorously stirring at room temperature for 24 hours;
S3: after washing the polymerization and the polydopamine coated GO with the DI water by centrifugation at 15000 rmp for 15 minutes each time and re-dispersing the polymerization and the polydopamine coated GO into the DI water to obtain re-dispersed GO solution; dropping 0.06 mmol of Ammonium metavanadate (NH₄VO₃) into the re-dispersed GO solution, followed by freeze drying to obtain a dried sample;
S4: annealing the dried sample in a CVD furnace at 300° C. for 1 hour under 200 sccm Ar, which was then mixed with 20 mg of selenium powder and undergoing selenization by the dried sample at 500° C. for 30 minutes, with the carrier gas of 50 sccm Ar and 10 sccm H₂ gases to obtain the VSe₂ material with graphene support composite, where the VSe₂ material is for aqueous zinc ions cells.

In another aspect, a zinc ions battery includes an Zn anode, a cathode material, a separator and an electrolyte, wherein: a highly conductive VSe₂ with graphene support composite coated on the Zn metal as anode (VSe₂/Zn) electrode is provided. The electrolyte is zinc salt. The separator used is glass fiber.

In some embodiments, two electrochemical whole cells include a coin-typed zinc ion secondary battery and pouch cell with VSe₂ coated Zn anode. The cathode material is α-MnO₂ coated on carbon cloth, and the separator is glass fiber, the electrolyte used in 2 M ZnSO₄.

In a further aspect, the HER prohibition test is also provided, which is conducted in a three-electrode system comprising a working electrode (Zn or coated VSe₂/Zn), a reference electrode (silver chloride) and a counter electrode (Zn) and a 2 M Na₂SO₄ as electrolyte. The process may include applying a potential to deposit Zn on working electrode to investigate the hydrogen gas generation. The cycle lifespan of the symmetric cells is provided, and the Coulombic efficiency test of the half cell is provided.

### BRIEF DESCRIPTION OF THE DRAWINGS

FIG. 1 demonstrates the synthesis process of VSe₂ with graphene support composite.

FIG. 2 is a representative high-solution transmission electron microscope (HRTEM) and corresponding selected-area diffraction (SAED) pattern, and elemental mapping of VSe₂ with graphene support composite, where Chart a and Chart b exhibit the HRTEM and SAED of VSe₂ with graphene support composite and Chart c exhibits the EDS mapping.

FIG. 3 is a representative X-ray diffraction pattern of VSe₂ with graphene support composite.

FIG. 4 is a representative X-ray photoelectron spectroscopy of VSe₂ with graphene support composite, where Chart a illustrates V 2p spectrum, Chart b illustrates Se 3d spectrum, and Chart c illustrates three types of nitrogen doping of graphene.

FIG. 5 is a graph of cyclic voltammetry (CV) test for the electroreduction process of Zn deposition on pure Zn or VSe₂/Zn, according to the Example 3.

FIG. 6 is a graph of Linear sweep voltammetry curve of HER reaction in a 2 M aqueous Na₂SO₄ electrolyte at a scan rate of 1 mV s⁻¹ with Zn or VSe₂/Zn as working electrode, according to the Example 4.

FIG. 7 is the cycling performance of the VSe₂/Zn anode of example 5 and 6 at 1 mA cm² and 1 mAh cm⁻² conditions compared with bare Zn anode.

FIG. 8 is the cycling performance of the VSe₂/Zn anode of example 5 and 6 at 2 mA cm² and 1 mAh cm⁻² conditions compared with bare Zn anode.

FIG. 9 is a representative SEM image for Zn depositing on bare Zn (FIGS. 10a and 10b) and on VSe₂/Zn (FIGS. 10c and 10d) at 1 mA/cm² and 3 mAh/cm² according to Example 5 and 6.

FIG. 10 is a representative X-ray diffraction pattern for the textural change of deposited Zn during the continues electrochemical deposition process according to Example 6.

FIG. 11 is a graph of Coulombic efficiency of planar Cu and VSe₂/Cu half cells at 1 mA cm² and 1 mAh cm⁻² conditions, according to the Example 7.

FIG. 12 is a graph of morphology characterization in half cells at 1 mA/cm², 1 mAh/cm² after 10 cycles on bare Cu foil and on the VSe₂/Cu foil.

FIG. 13 is a graph of long-term cycling performance for ZIBs with VSe₂/Zn anode and α-MnO₂ cathode at 1 A g⁻¹. FIG. 13a represents the cycling performance, FIG. 13b represents the charge/discharge curves at various cycles in ZIBs with VSe₂/Zn anode and α-MnO₂ cathode.

FIG. 14 is a graph of cycling performance for pouch cells at 1 A g⁻¹.

### DESCRIPTION OF EMBODIMENTS

Various embodiments are described below. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Herein, we report a novel material, 1T graphene-like vanadium diselenide (VSe₂) as the functional layer on the Zn anode for dendrite inhibition and side reaction retraction. The synthesis process includes chemical vapor deposition (CVD), below is the details for the synthesis process:
S1: The graphene oxide (GO) was prepared by a modified Hummers method, which chemically separate the graphite interlayer by adding functional groups and then dispersed into 100 ml of the deionized (DI) water;
S2: Then, 200 mg of polydopamine was added into the GO solution and stirred for 30 minutes to ensure a good mix. 100 mg of Tris-HCl was added into the dispersion and followed by vigorous stirring at room temperature for 24 hours;
S3: After the polymerization, polydopamine coated GO was washed with DI water by centrifugation at 15000 rmp for 15 minutes each time and re-dispersed into DI water. 0.06 mmol of Ammonium metavanadate (NH₄VO₃) was dropped into the re-dispersed GO solution, followed by freeze drying;
S4: The dried sample was firstly annealed in the CVD furnace at 300° C. for 1 hour under 200 sccm Ar, which was then mixed with 20 mg of selenium powder and undergo selenization at 500° C. for 30 minutes, with the carrier gas of 50 sccm Ar and 10 sccm H₂ gases to synthesize the VSe₂ crystals on graphene support composite for the aqueous zinc ions cells.

With this functional layer on the Zn anode, it increases the close-packed Zn (002) facet fraction on the surface during the Zn deposition process, resulting in regular Zn deposition morphology and the cycling stability improvement. From the X-ray diffraction pattern (XRD) results, Zn deposition on VSe₂ expose more Zn (002) basal planes and more hexagon Zn crystal were formed, indicating a reorientated transition of deposited Zn atom during the continuous reduction. As for the electrochemical performance, the half cells with VSe₂ electrode demonstrated a distinguished CE of above 99%, and the cycling lifespan of the symmetric cell was up to 2500 cycles with about 50 mV overpotential in 1 mA cm⁻² with the capacity of 1 mAh cm⁻². In addition, the protective layer can suppress the corrosion in the ZnSO₄ electrolyte and retard the HER side reaction.

As provided in more detail below, the VSe₂/Zn electrode is fabricated with a functional VSe₂ layer coated on a pure Zn metal. By using modified electrode to replace the conventional metal and graphene-based matrix, smoother and dendrite-free deposition surface can be achieved. 1T VSe₂/Zn anode is beneficial in regulating Zn crystal morphology from randomly oriented to horizontally (002)-oriented plate-like, which enhances the reversibility of active Zn metal and cycling performance in ZIBs. In addition, the protective layer can suppress the corrosion in the ZnSO₄ electrolyte and retard the HER side reaction in the potentiostatic sweep test, which is also favorable for the cell's lifespan.

The rechargeable aqueous zinc ions cells provided herein can be run in an open-air atmosphere, which exhibit prolong cycling life and stability. The coin-typed electrochemical cells include electrolyte that have zinc ions. The functional layer described herein may be used in zinc ions batteries and other metal batteries

### Embodiments

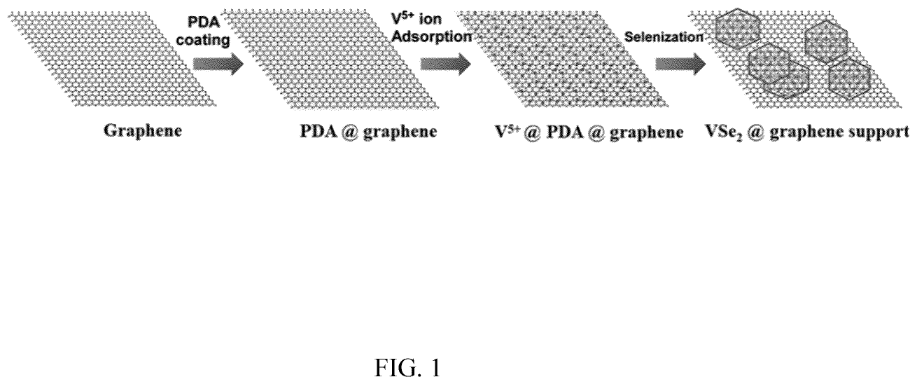

Embodiment 1. A thin functional layer synthesis technique. The preparation process of VSe₂ film with graphene support is illustrated in FIG. 1. The graphene oxide (GO) was prepared by a modified Hummers method and dispersed into 100 ml of the deionized (DI) water. Then, 200 mg of dopamine (PDA) was added into the GO solution and stirred for 30 minutes to ensure a good mix. 100 mg of Tris-HCl was added into the dispersion and followed by vigorous stirring at room temperature for 24 hours. After the polymerization, polydopamine coated GO was washed with DI water by centrifugation at 15000 rmp for 15 minutes each time and re-dispersed into DI water. 0.06 mmol of Ammonium metavanadate (NH₄VO₃) was dropped into the re-dispersed GO solution, followed by freeze drying. The dried sample was firstly annealed in the chemical vapor deposition (CVD) furnace at 300° C. for 1 hour under 200 sccm Ar, which was then mixed with 20 mg of selenium powder and undergo selenization at 500° C. for 30 minutes, with carrier gas of 50 sccm Ar and 10 sccm H₂ gases to get the VSe₂ with graphene support composite. All chemicals with analytical grade were purchased from Sigma-Aldrich without further treatment and the DI water was used throughout the whole experiment.

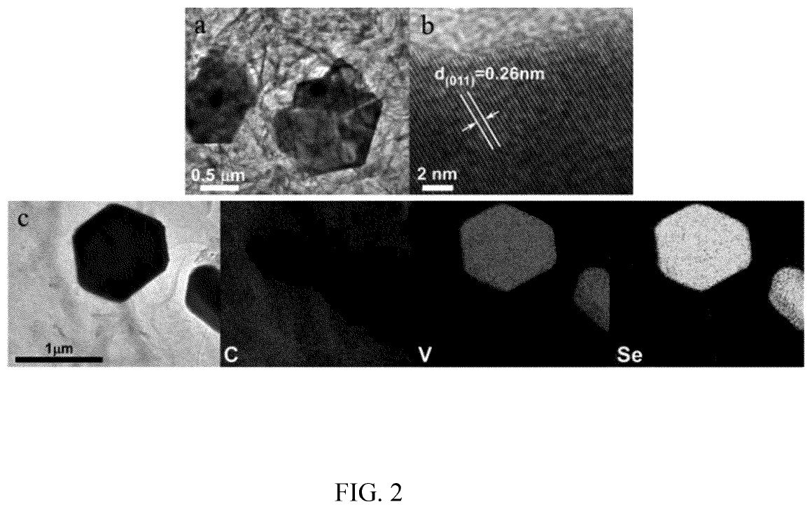

The morphology and structure of VSe₂ are characterized using HRTEM with SAED. Hexagonal-shaped single crystal of VSe₂ with the size about 1 um is observed in Chart a, FIG. 2. From the SAED image (Chart b, FIG. 2), the inter-planer distance of 0.26 nm can be found, which is ascribed to the (011) plane of VSe₂, confirming the synthesis of VSe₂. And the Energy dispersive analysis (EDS) is shown in Chart c, FIG. 2, to further confirm the hexagonal-shaped VSe₂ material, which can be found in the mapping results.

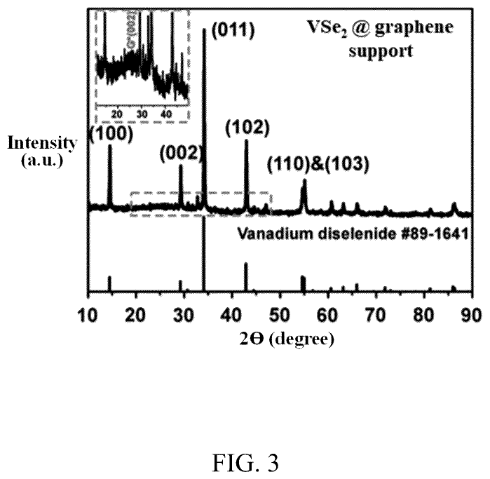

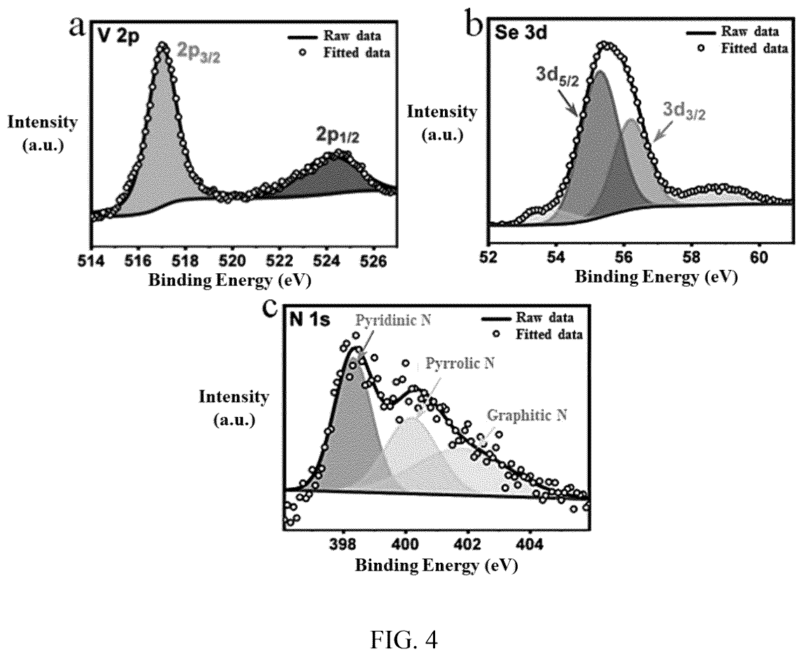

FIG. 3 illustrates the crystal structure of VSe₂ on graphene support, where a diffraction peak at 25.3° corresponds to the (002) lattice plane of reduced graphene oxide. The distinct peaks at 14.6°, 29.3°, 34.3°, 43.0°, 54.7° and 55.1° indicate the VSe₂ plane of (100), (002), (011), (102), (110) and (103), respectively, to further confirm the VSe₂ crystal structure. And FIG. 4, the XPS results display the high resolution 2p, 3d and is spectra of V, Se and N. From V 2p spectrum (Chart a, FIG. 4), the binding energy at 517.1 and 524.4 eV represent the V 2p_{3/2} and V 2p_{1/2} orbitals, respectively. In Se 3d spectrum (Chart b, FIG. 4), the divided peaks located at 55.3 and 56.2 eV associate to the Se 3d_{5/2} and Se 3d_{3/2} orbitals, respectively. Moreover, in Chart c, FIG. 4, three types of nitrogen doping are identified from the peaks at 398.3, 400.2 and 401.9 eV, attributed to the pyridinic N, pyrrolic N and graphitic N of reduced graphene oxide, respectively.

Embodiment 2. As for the coated VSe₂/Zn and VSe₂/Cu electrode synthesis, the produced VSe₂ with graphene support powder were mixed with conductive carbon Super P (Canrd) and the binder poly (vinylidene fluoride) (PVDF, Sigma-Aldrich) (7:2:1, mass ratio) separately, then 1-methyl-2-pyrrolidone (NMP, anhydrous) solvent was added and stirred together to get a uniform slurry. The formed slurry was then coated onto a Zn or Cu foil and cut into disks (Φ=16 mm) after drying in a vacuum oven at 60° C. for 24 h.

Embodiment 3. A three-electrode system for cyclic voltammetry (CV) testing including working electrode, reference electrode and counter electrode, wherein Zn or coated VSe₂/Zn used as working electrode, silver chloride as reference electrode and Zn as counter electrode and a 2 M ZnSO₄ as media. The electrochemical whole cell was kept static at least 10 min. The area of working electrode and counter electrode is 1×1 cm². The process may include applying a potential to deposit Zn on working electrode to investigate the electroreduction process and hydrogen gas generation. All the galvanostatic discharge-charge performance was obtained in the CT2001 A test instrument (LAND Electronic Co, China).

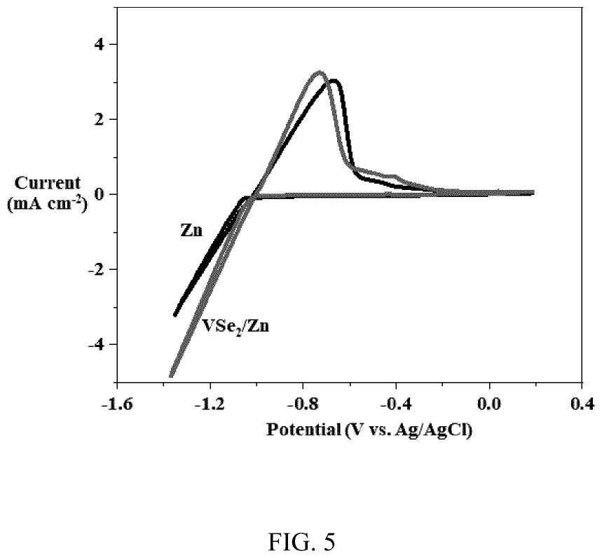

FIG. 5 illustrates the electroreduction process for the Zn deposition on pure Zn and VSe₂/Zn, where the Zn desorption and deposition process can be shown. For the deposition on VSe₂/Zn, it exhibits larger reaction current density and lower nucleation overpotential, meaning the fast ions diffusion and better wettability with Zn on the VSe₂/Zn surface compared with pure Zn.

Embodiment 4. A three-electrode system for Linear sweep voltammetry (LSV) testing including working electrode, reference electrode and counter electrode, wherein Zn or coated VSe₂/Zn used as working electrode, silver chloride as reference electrode and Zn as counter electrode and a 2 M Na₂SO₄ as media. The area of working electrode and counter electrode is 1×1 cm². The electrochemical whole cell was kept static at least 10 min. The system was operated in a CHI660e electrochemical station (Shanghai Chenhua, China). The process may include applying a potential to deposit Zn on working electrode to investigate the electroreduction process and hydrogen gas generation.

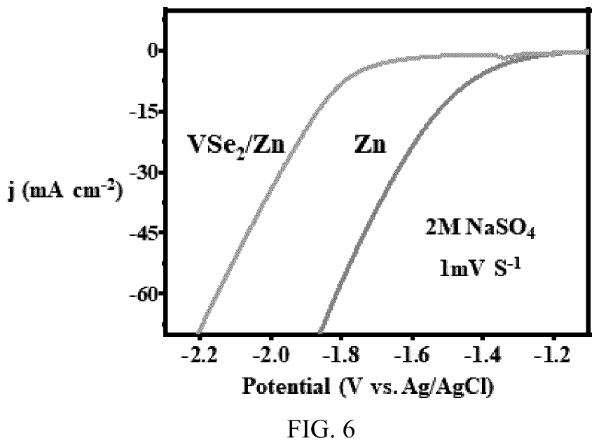

FIG. 6 illustrates the Linear sweep voltammetry (LSV) test in a three-electrode protocol at 1 mV s⁻¹. The hydrogen evolution reaction potential of VSe₂/Zn anode is 1.84 V, which is higher than that of bare Zn anode with 1.47 V, indicating the parasitic reaction resistance with the assistance of VSe₂ film on the Zn anode surface.

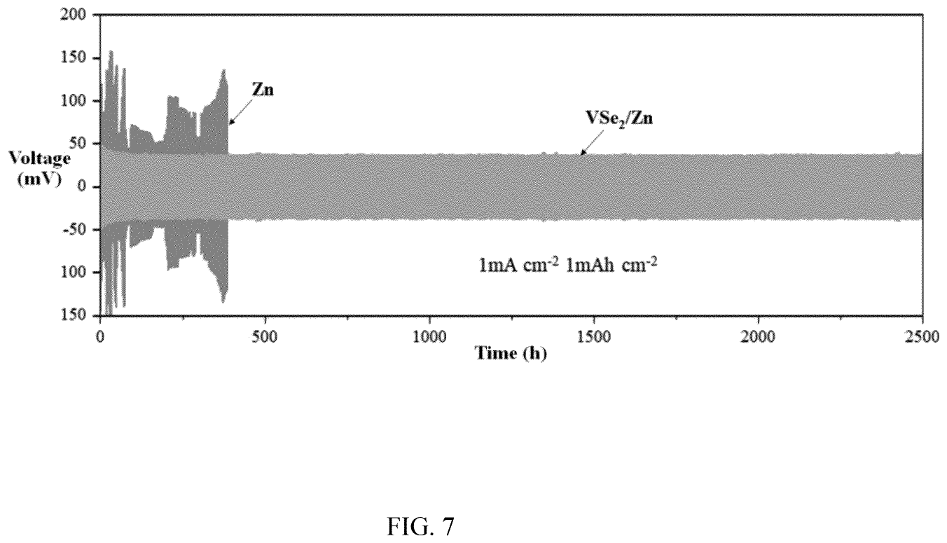

Embodiment 5. Preparation of an electrochemical cell. Coin-typed symmetric cells were assembled using two Zn foils (99.9%, Sigma-Aldrich Corporation) as the anode and cathode, 2 M ZnSO₄ (ZnSO₄·7H₂O, Sigma-Aldrich Corporation) as electrolyte, and glass fiber (420 um, Whatman™ GF/F) as the separator. The diameter of the separator is 19 mm, The diameter of the Zn foils is 16 mm and CR2016 coin cell cases (MTI Corporation) were used. A current of 1 mA cm⁻² and a capacity of 1 mAh cm⁻² were applied to the cells for cyclic capability testing, the lifespan shown in FIG. 7 is about 320 h and then it suffered from severe short circuit.

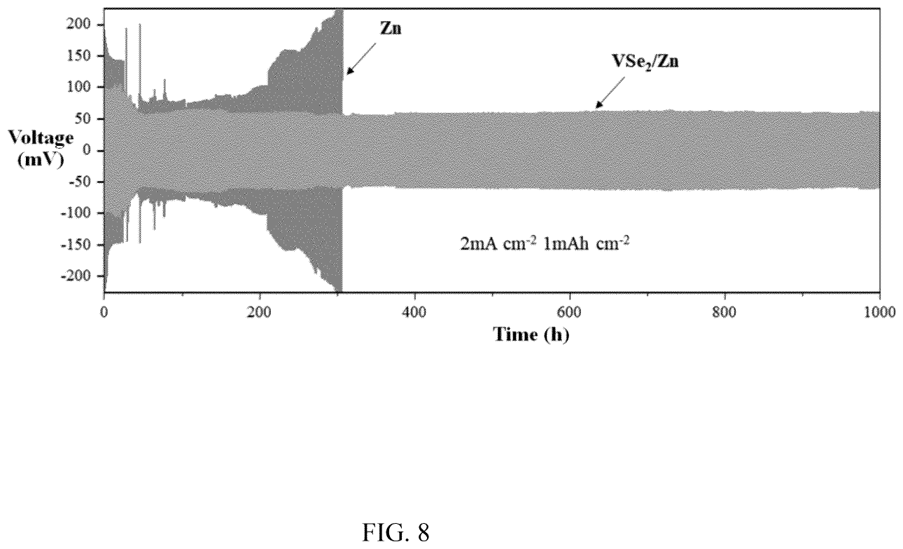

And a higher current density of 2 mA cm² and a capacity of 1 mAh cm⁻² were applied to the symmetric cells for cycle life testing, the lifespan shown in FIG. 8 is about 245 h, which is shorter than that under a lower current density of 1 mA cm⁻². All the galvanostatic discharge-charge performance herein and below was obtained in the CT2001 A test instrument (LAND Electronic Co, China).

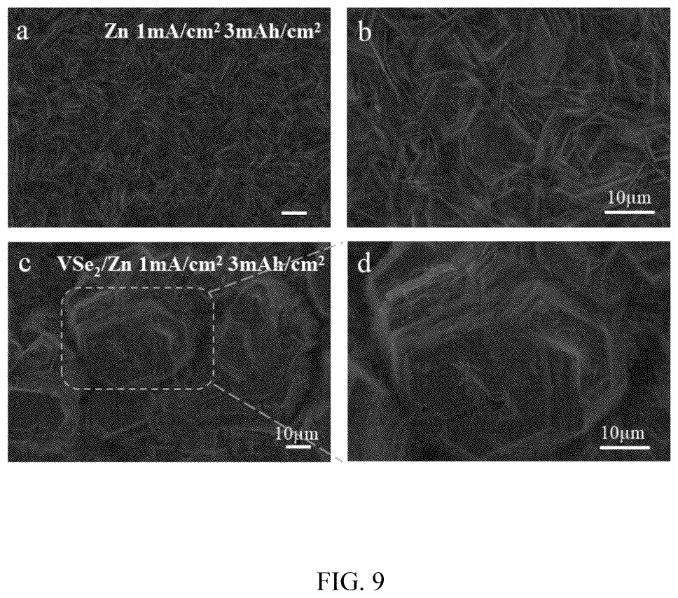

Scanning electron microscope (SEM) was conducted to reveal the electrodeposition morphology of Zn on pure Zn substrate at 1 mA cm² and 3 mAh cm⁻² (FIGS. 9a and 9b), where we captured the deposited Zn on the pure Zn substrate is disordered and irregular, where the brutal pits and chips will penetrate the separator to cause the short circuit.

Embodiment 6. A coin-typed symmetric cells were assembled and cycled in the same conditions to the Example 1 with the exception that the anode and cathode are VSe₂/Zn foils. In 1 mA cm² and 1 mAh cm⁻² cycling conditions, the cell with VSe₂/Zn maintains an exceedingly stable charge/discharge process for 2500 h without voltage variation, shown in FIG. 7, which is quite longer than that of non-modified Zn in the symmetric cell. And when the current density increasing to 2 mA cm² for plating/striping, VSe₂/Zn cell displays a 1000 h cycle life (FIG. 8), much better than that of non-modified Zn (245 h). The excellent cycling performance specifies that the VSe₂-coated Zn benefits the layer-to-layer planar deposition without dendrite generation.

SEM images (FIGS. 9c and 9d) show the deposition morphology of Zn on VSe₂/Zn substrate at 1 mA/cm² and 3 mAh/cm², where the horizontally stacking hexagonal Zn platelet parallel to the VSe₂/Zn substrate can be observed. As aforementioned, VSe₂ overlayer stabilizes the Zn anode throughout guiding regular Zn (002) growth.

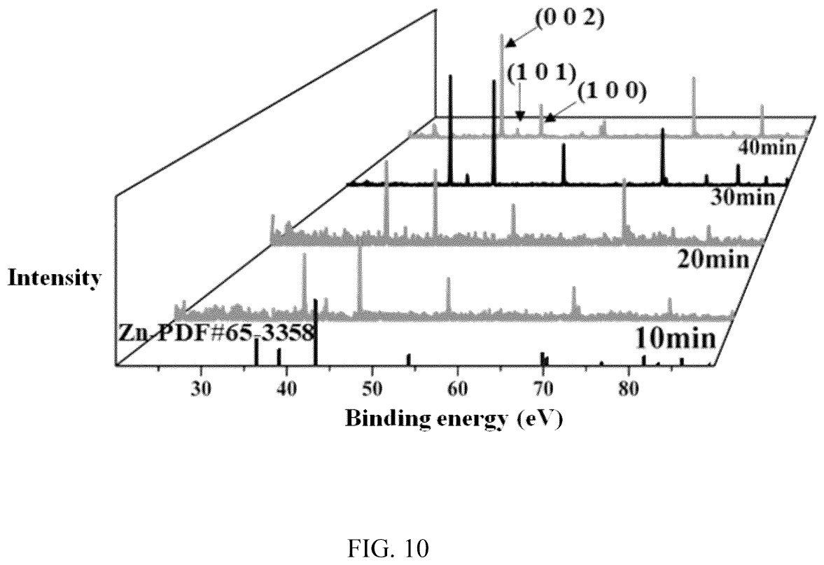

X-ray diffractions was conducted to determine the crystal lattice pattern of deposited Zn above the VSe₂/Zn electrode for different deposition times. FIG. 10 displays the highest Zn (002) peak intensity with the diffraction angle of 36.290° after 40 min deposition compared with other deposition times 0, 10, 20, or 30 min. Zn on VSe₂/Zn undergoing a reorientation transition during continuous deposition, indicating more (002) basal planes are exposed and more hexagon Zn crystal formed, which will lessen the formation of dendrite and stabilize the cycling.

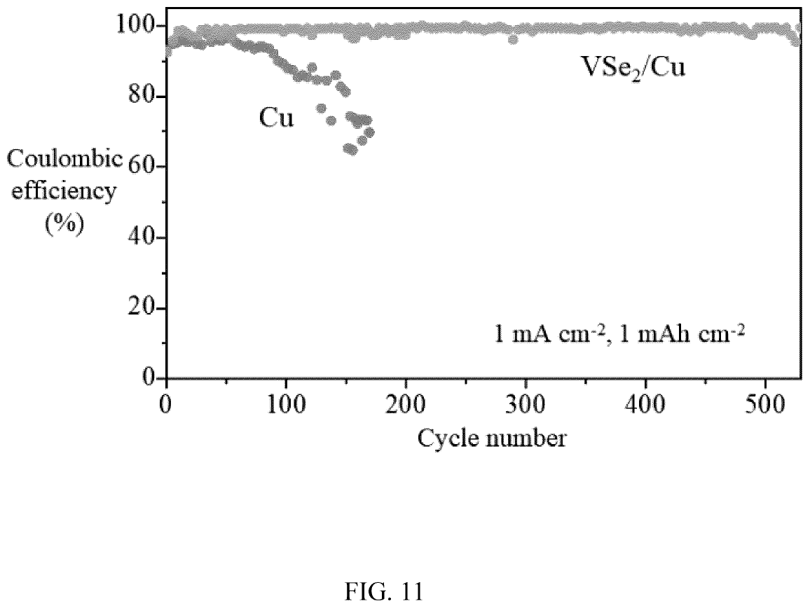

Embodiment 7. Coin-typed half cells were assembled using Zn foils as the anode and pure Cu (99.9%, Sigma-Aldrich Corporation) or VSe₂/Cu as cathode, glass fiber (420 um, Whatman™ GF/F) as the separator, 2 M ZnSO₄ as electrolyte. The Coulombic efficiency of planar Cu and VSe₂/Cu was evaluated to test the reversibility. FIG. 11 presented a remarkably steady CE exceeding 99.0% upon 530 cycles, which is attributed to the protective VSe₂ overlayer in comparison of nonmodified Cu (a dramatic decrease to <80% after 100 cycles), confirming the high reversibility of VSe₂/Cu.

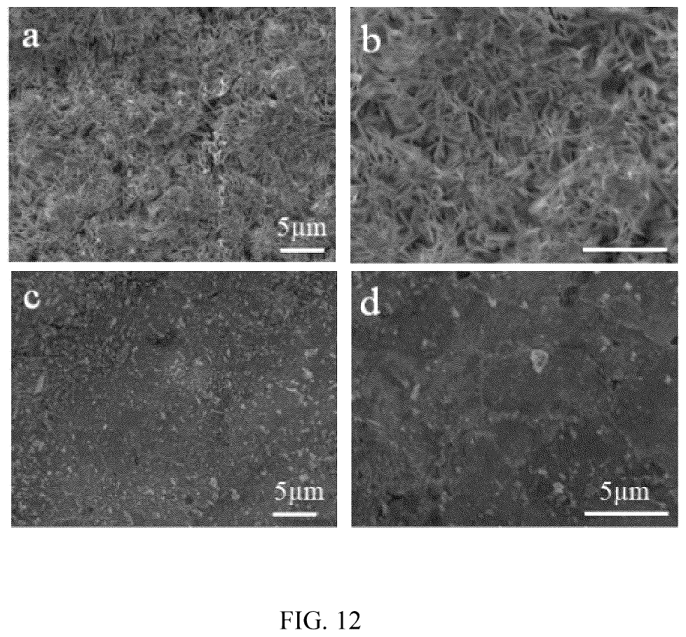

FIG. 12 demonstrates the surface morphology characterization of half cells at 1 mA/cm², 1 mAh/cm² condition after 10 cycles. It is evident that randomly moss-like or plate-like Zn deposits on pure Cu foil (FIG. 12a), the magnification can be seen in FIG. 12b. On the VSe₂/Cu, the denser and planer surface without much dendrite formation were validated by SEM images (FIGS. 12c and 12d). The rapid diffusion of Zn and better zincophilic property between VSe₂ and Zn ensure the uniform distribution and less dendrite emergence.

Embodiment 8. Coin-typed whole cells were assembled using Zn foil or VSe₂/Zn as the anode and α-MnO₂ coated on the carbon cloth as cathode, glass fiber as the separator, 2 M ZnSO₄ as electrolyte. As for the cathode preparation, firstly, 0.15M MnSO₄·H₂O was mixed with 0.1M KMnO₄ solution by the volume ratio of 1:1, and then transferred into a Teflon-lined autoclave at the condition of 160° C. for 12 h. After cooling and centrifugation, the precipitate was dried for 24 h and got the α-MnO₂ powder. Then α-MnO₂ powder were mixed with carbon Super P (Canrd) and the binder poly (vinylidene fluoride) (PVDF, Sigma-Aldrich) (7:2:1, mass ratio), then 1-methyl-2-pyrrolidone (NMP, anhydrous) solvent was added and stirred together to get a uniform slurry. The formed slurry was then coated onto a carbon cloth and cut into disks after drying in a vacuum oven at 80° C. for 12 h to get the cathode material.

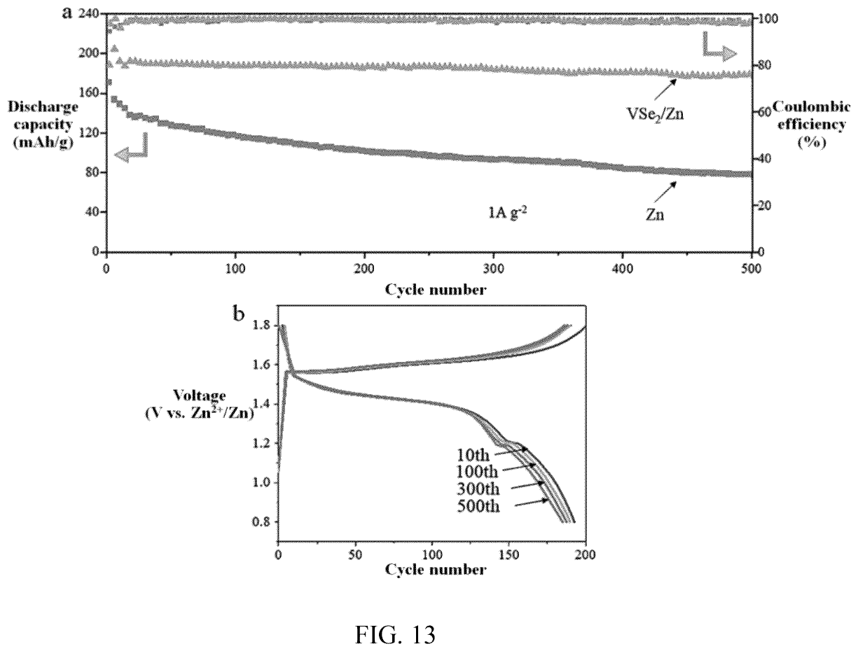

FIG. 13a shows the discharge capacity during battery operation at A g⁻¹, where the capacity of VSe₂/Zn∥α-MnO₂ after the first cycle is 195 mAh g⁻¹ with retention of 94.7% after 500 cycling, which is better than using Zn anode. And FIG. 13b supplies the intrinsically steady capacity discharge process including 10^{th}, 100^{th}, 300^{th} and 500^{th} cycle.

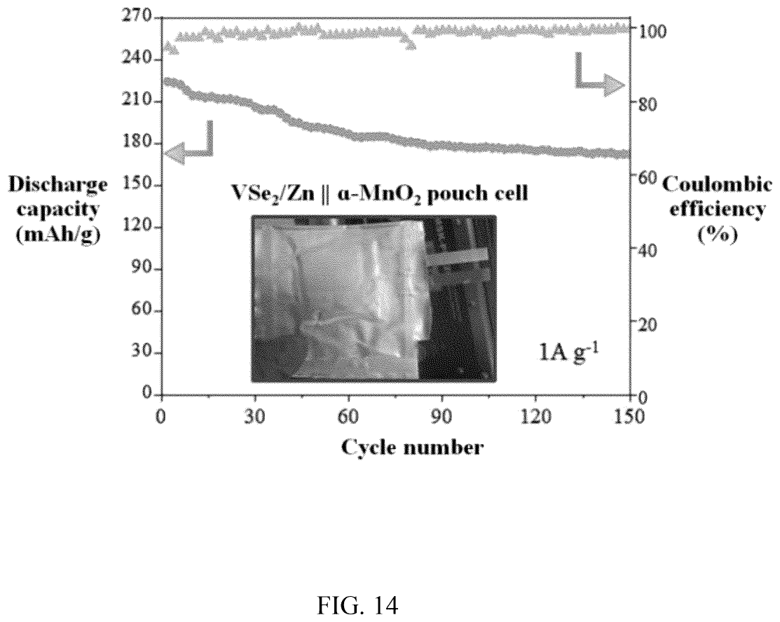

Embodiment 9. Pouch cells were assembled to verify the application potential of the materials, where using 2×2 cm² VSe₂/Zn as the anode and 2×2 cm² α-MnO₂ coated on the carbon fiber cloth with a mass loading of 2 mg cm⁻² as cathode, glass fiber as the separator, 2 M ZnSO₄ as electrolyte. FIG. displayed a relatively high capacity with the retention of 83.2% for 150 cycles (FIG. 14).

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

What is claimed is:

1. A method of preparing a VSe₂ material, comprising:
preparing graphene oxide (GO) by a modified Hummers method and dispersing the GO into 100 ml of deionized (DI) water to obtain GO solution; then adding 200 mg of polydopamine into the GO solution and stirring for 30 minutes to ensure a good mix; adding 100 mg of Tris-HCl into dispersion and vigorously stirring the 100 mg of the Tris-HCl with the dispersion at room temperature for 24 hours; after washing the polymerization and the polydopamine coated GO with the DI water by centrifugation at 15000 rmp for 15 minutes each time and re-dispersing the polymerization and the polydopamine coated GO into the DI water to obtain re-dispersed GO solution; dropping 0.06 mmol of Ammonium metavanadate (NH₄VO₃) into the re-dispersed GO solution, followed by freeze drying to obtain a dried sample; annealing the dried sample in a CVD furnace at 300° C. for 1 hour under 200 sccm Ar, then mixing the dried sample with 20 mg of selenium powder and undergoing selenization by the dried sample at 500° C. for 30 minutes, with carrier gas of 50 sccm Ar and 10 sccm H₂ gases to obtain the VSe₂ material with graphene support composite, where the VSe₂ material is for aqueous zinc ions cells.

2. An electrochemical whole cell, comprising:
an anode;
a α-MnO₂ coated on a carbon fiber cathode;
a glass fiber as a separator; and
an aqueous electrolyte comprising a zinc salt;
wherein the electrochemical whole cell is a zinc ion cell that is kept static for at least 4 h, the anode of the electrochemical whole cell is Zn or VSe₂/Zn, the separator is capable of soaping on the aqueous electrolyte comprising the zinc salt for 1 h before utilization, and the aqueous electrolyte is 2 M ZnSO₄, or other concentration of ZnSO₄ or a mixture of any two or more thereof.

3. The electrochemical whole cell of claim 2, wherein the VSe₂/Zn is constructed with a functional VSe₂ layer with graphene support coated on a pure Zn metal; the functional VSe₂ layer with graphene support is a powder and then mixed with Super P (Canrd) and binder poly (vinylidene fluoride), then 1-methyl-2-pyrrolidone solvent is added and stirred together to obtain a uniform slurry to coat on a Zn metal surface; a thickness of the functional VSe₂ layer on the pure Zn metal is about 120 μm.

4. The electrochemical whole cell of claim 2, wherein the α-MnO₂ coated on the carbon fiber cloth, the α-MnO₂ powder mixed with Super P (Canrd) and the binder poly (vinylidene fluoride), then the 1-methyl-2-pyrrolidone solvent is added and stirred together to obtain a uniform slurry to coat on the carbon cloth surface; a thickness of a VSe₂ layer on a Zn metal is about 150 μm.

5. The electrochemical whole cell of claim 2, wherein the separator is glass fiber with a thickness of 420 μm, a diameter of the separator is about 19 mm.

6. The electrochemical whole cell of claim 2, the electrolyte is composed of zn²⁺, the aqueous electrolyte is 2 M ZnSO₄.

7. An electrochemical symmetric cell, comprising:
an anode;
a cathode;
a glass fiber as separator; and
an aqueous electrolyte comprising a zinc salt;
wherein the electrochemical whole cell is kept static at least 4 h, the separator is capable of soaping on zinc salt electrolyte for 1 h before utilization; the aqueous electrolyte is 2 M ZnSO₄, or other concentration of ZnSO₄ or a mixture of any two or more thereof.

8. The electrochemical symmetric cell of claim 7, wherein two kinds of symmetric cells are assembled.

9. The electrochemical symmetric cell of claim 7, wherein one of the two kinds of the symmetric cells adopts two Zn foils as the anode and the cathode, the glass fiber with a thickness of 420 μm and a diameter of 19 mm as the separator, 2 M ZnSO₄ as the aqueous electrolyte; another one of the two kinds of the symmetric cells adopts two VSe₂/Zn foils as the anode and the cathode, the glass fiber with the thickness of 420 μm and the diameter of 19 mm as the separator, the 2 M ZnSO₄ as the aqueous electrolyte.
